(19) United States
(12) Patent Application Publication
(10) Pub. No.: US 2006/0238361 A1
(43) Pub. Date: Oct. 26, 2006

(54) Apparatus and method for potty-training young children

(76) Inventor: Karla Donlin, St. Cloud, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/351,334

(22) Filed: Feb. 9, 2006

Related U.S. Application Data
(60) Provisional application No. 60/651,161, filed on Feb. 9, 2005.

(51) Int. Cl. G08B 23/00

(52) U.S. Cl. 340/573.5; 368/10; 368/109

(57) ABSTRACT

An apparatus, a system and methods of implementing the apparatus and system so as to successfully prompt a wearer to attempt use of a toilet. A portable timing device is adapted to be worn so as to accompany the wearer wherever the wearer goes. The portable timing device can include an adjustable timer for measuring and indicating a time interval since the last successful or unsuccessful attempt at using the toilet. Upon the timer reaching the end of a selected timing period, an alarm or indicator can be activated to provide the wearer with an indication that use of the toilet should be attempted without requiring a reminder or directive by a parent, relative or other caregiver. The portable timing device can include pictures, designs, recognizable sounds and the like which can make wearing and use of the portable timing device desirable to a wearer.

The present application claims priority to U.S. Provisional Patent Application Ser. No. 60/651,161 filed Feb. 9, 2005 and entitled, “APPARATUS AND METHOD FOR POTTY-TRAINING YOUNG CHILDREN”, which is herein incorporated by reference in its entirety.

### FIELD OF THE INVENTION

The invention relates generally to the field of wearable training tools. More particularly, the present invention pertains to a portable timer device for prompting a wearer to attempt use of a toilet at desired time intervals.

### BACKGROUND OF THE INVENTION

A common situation experienced by all parents during the development and growth of their children is the process of “potty-training” their children. Successful potty-training of young children is desired by parents as the time, expense and inconvenience associated with continually changing diapers is eliminated. For children, successful potty-training provides increased self-esteem and a sense of accomplishment and being grown-up. While the end result is desired by both parents and children, the process of potty-training is unique for each child and may in fact lead to frustration on the part of both parent and child.

Recognizing the difficulties experienced during the potty-training process, numerous books have been written and methods developed to assist parents with the toilet training process. However, no one method or process is suitable for every child as the potty-training process varies based upon a child's personality, intelligence and maturity. Children with independent natures can be especially difficult to potty-train as they generally wish to do and learn things on their own and may not be receptive to suggestions by their parents. As such, it would be advantageous to have a potty-training method that provides children, especially independent children, with an opportunity to successfully attempt the potty-training process.

### SUMMARY OF THE INVENTION

The present disclosure addresses an apparatus, a system and methods of implementing the apparatus and system so as to successfully prompt a wearer to attempt use of a toilet. A portable timing device is adapted to be worn so as to accompany the wearer wherever the wearer goes. The portable timing device can comprise an adjustable timer for measuring and indicating a time interval since the last successful or unsuccessful attempt at using the toilet. Upon the timer reaching the end of a selected timing period, an alarm or indicator can be activated such as, for example, an audible, visual or vibratory alarm, so as to provide the wearer with an indication that use of the toilet should be attempted without requiring a reminder or directive by a parent, relative or other caregiver. The portable timing device may comprise pictures, designs, recognizable sounds and the like which can make wearing and use of the portable timing device desirable to a wearer.

In one aspect, a portable timing device is adapted to be worn by a child. The portable timing device can include a magnetic attachment for attaching and retaining the timing device on the child's clothing such as, for example, on a jacket, shirt, pants, shorts or shoes. The portable timing device can further comprise an audible, visual or vibratory alarm or indicator for communicating the end of a timed cycle to a child. Upon hearing, seeing or feeling the alarm, the child is notified that an attempt should be made to use the toilet.

In another aspect, a potty-training system for use in potty-training a young child comprises a portable timing device and a children's book. The portable timing device can comprise an attachment member such as, for example, a magnetic attachment member, such that the portable timing device can be retainably attached to the child's clothing. The portable timing device comprises a programmable timing circuit allowing a child's parents to set a timing sequence based on desired intervals for attempting to use the toilet. Desired intervals are adjustable and can range from minutes to hours in length. Upon expiration of the timing interval, the timing circuit can initiate an audible, visual or vibratory alarm or indicator for reminding the child to attempt use of the toilet without requiring direction from an adult. When attempting use of the toilet, a children's book related to the subject of potty-training can be read by a parent, relative or other caregiver so as to make the child feel comfortable and to enhance the likelihood of success in using the toilet. The children's book can in some presently preferred embodiments relate to a fictional character that is displayed on the portable timing device. In some embodiments, the portable timing device and children's book can include well-known children's characters to further promote the child's desire to use the potty-training system.

In another aspect, the disclosure relates to a method for potty-training children. The method can comprise attaching a portable timing device to a child's clothing to provide an alarm or indication to the child upon expiration of a selecting time interval. The alarm indicates to the child that an attempt is to be made to use the toilet. During the attempt to use the toilet, a children's book relating to the subject of potty-training can be read by a parent, relative or caregiver so as to enhance the likelihood of success by maintaining a consistent theme during the potty-training process.

In another aspect, a portable timing device is adapted to be worn by an adult suffering from health issues such as, for example, incontinence or forgetfulness.

The above summary of the various embodiments of the invention is not intended to describe each illustrated embodiment or every implementation of the invention. The figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a front view of a portable timing device.

FIG. 2 is a rear view of the portable timing device of FIG. 1.

FIG. 3 is a section view of the portable timing device of FIG. 1 taken at Line 3-3 of FIG. 1.

FIG. 4 is a front view of the portable timing device of FIG. 1 with a front cover in an open disposition.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

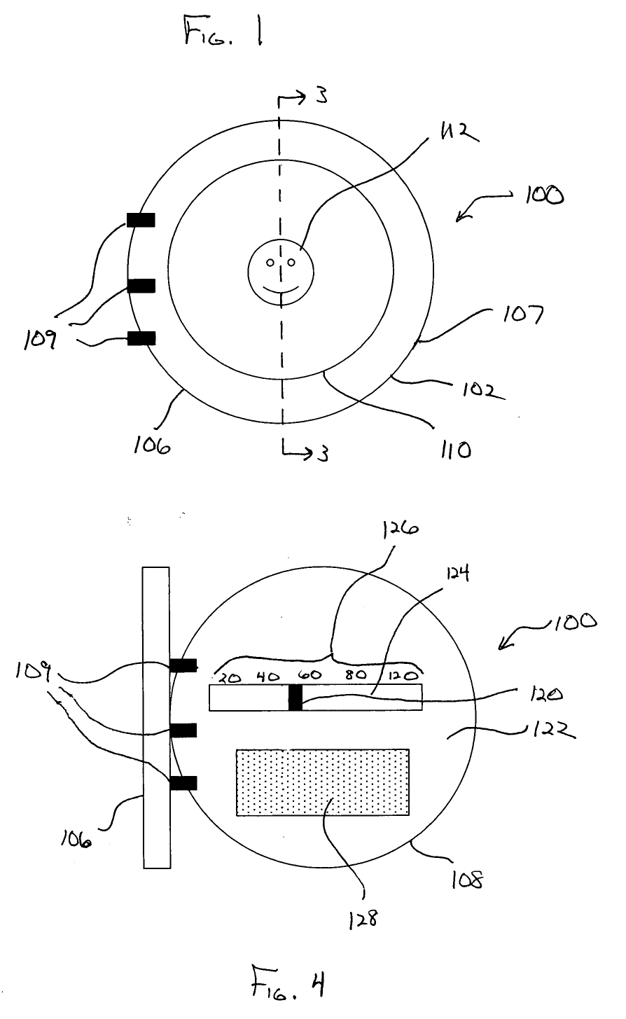

As illustrated in FIGS. 1, 2, 3 and 4, a portable timer device 100 comprises a front portion 102 and rear portion 104. Front portion 102 comprises a front cover 106 and a front housing 108. Front portion 102 has an exterior perimeter 107 that can resemble shapes such as a circle, square or triangle. Alternatively, exterior perimeter 107 can resemble the outline of a familiar symbol or character recognizable to and/or enjoyed by a wearer.

Front cover 106 is operably joined to front housing 108 with a hinge assembly 109. Front cover 106 can comprise a picture window 110 for displaying a visual element 112. Visual element 112 can comprise any suitable visual element such as, for example, shapes, symbols or fictional characters that are commonly known and enjoyed by wearers. Examples of suitable visual characters for use with children can comprise literary characters, cartoon characters, video game characters or characters associated with children's television programs and movies such as, for example, children's programs and movies created by the Disney Corporation and Nickelodeon Television Network. Picture window 110 can also be adapted so as to allow a parent, relative, guardian or other caregiver to insert a personal photograph or picture.

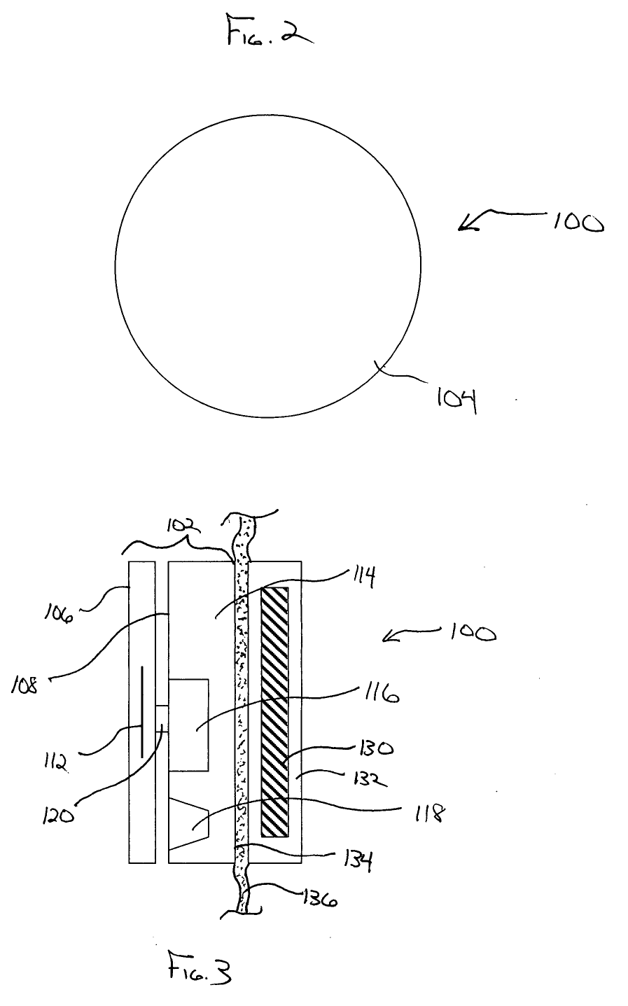

As illustrated in FIG. 3, front housing 108 comprises an interior space 114 in which a mechanical timer 116 and an audio speaker 118 are retainably positioned. Mechanical timer 116 comprises an adjustment arm 120 projecting out of the interior space 114.

Front portion 102 is illustrated in FIG. 4 with front cover 106 rotatably positioned about hinge assembly 109 such that the front cover 106 is in an open configuration with respect to the front housing 108. Front housing 108 further comprises an interface surface 122 having an opening 124, a timer legend 126 and a plurality of speaker bores 128. Opening 124 is sized to accommodate the adjustment arm 120. Timer legend 126 is labeled and spaced so as to correspond to a time setting of the mechanical timer 116. For example, when adjustment arm 120 is slidably adjusted to correspond with the number eighty, approximately eighty minutes remain before the mechanical timer times out and provides audio notice through audio speaker 118.

As shown in FIG. 3, rear portion 104 comprises a magnet 130 encapsulated within a wall 132. Rear portion 104 can substantially resemble the size and shape exterior perimeter 107 or can comprise an alternative configuration such as, for example, a smaller size so as to limit obtrusiveness to a wearer. Magnet 114 is selected so as to have a magnetic strength strong enough to magnetically engage a mounting surface 134 of the front housing 108 and retain the relative positions of the rear portion 104 and front portion 102 with respect to a piece of children's clothing 136 or apparel that physically separates the rear portion 104 from the front portion 102 as illustrated in FIG. 3.

In order to promote magnetic engagement of the front portion 102 and rear portion 104, front housing 108 can be fabricated of a suitable metal for magnetically engaging magnet 130. In some embodiments, both front housing 108 and front cover 106 can be fabricated of the same metallic material. In some embodiments, only front housing 108 is fabricated of the metallic material while front cover 106 may be fabricated of a suitable plastic material such as, for example, polycarbonate, polyethylene, polypropylene, polyvinylchloride or the like. In another alternative embodiment, front housing 108 can comprise a magnet having a polarity opposite of magnet 130 such that front housing 108 can be fabricated of a suitable plastic material.

In use, portable timer device 100 is adapted to be fixedly attached and worn by a wearer such as, for example, a young child throughout their daily routine. Rear portion 104 can be positioned on an interior side of clothing 136 while front portion 102 is positioned with mounting surface 134 against an exterior side of clothing 136 as shown in FIG. 3. Magnetic interaction between the magnet 130 and mounting surface 134 fixedly retains the position of the portable timer device 100 with respect to clothing 136 until purposely removed. Through the inclusion of visual element 112 on front cover 106, a child will be inclined to enjoy wearing portable timer device 100 and will not seek to separate the front portion 102 from the rear portion 104.

Either prior to or after attaching the portable timer device 100 to clothing 136, a parent, relative or caregiver can adjustably slide the adjustment arm 120 to correspond with a desired time duration before sounding an alarm. For instance, positioning the adjustment arm 120 relative to the number eighty on the timer legend 126 causes mechanical timer 114 to commence a timing sequence of eighty minutes in duration. Upon completion of the timing sequence, mechanical timer 114 initiates an audible alarm or warning through audio speaker 118. The audible alarm provides an indication to a child that they should then attempt to use the toilet. The audible alarm can take the form of an audible buzzer, chime or voice command. In some embodiments, a voice specific to a recognizable children's character such as, for example, a character displayed as visual element 112 can audibly direct the child to attempt use of the toilet.

During the child's attempt at using the toilet, the parent, relative or caregiver can read the child a children's book related to the subject of potty-training to provide further encouragement to the child. In one preferred embodiment, the children's book can be directed to a character that is displayed as visual element 112 on the portable timing device 100. Upon the child completing use of the toilet, mechanical timer 116 can be reset to commence another timing sequence by selectably positioning the adjustment arm 120 to correspond with a desired time interval as displayed by timer legend 126. In this manner, portable timing device 100 can be used repeatedly until the child has been successfully potty-trained.

The present disclosure describes aspects of one presently preferred embodiment of a portable timing device for use in potty-training small children. It will be understood by one of skill in the art that additional, alternative embodiments are contemplated and would not depart from the spirit and scope of the present disclosure. Representative alternative embodiments could comprise the replacement of mechanical timer 114 with a digital timer, display and battery for measuring and displaying a time sequence. Alternatively, audible speaker 118 could be replaced with a vibratory mechanism for vibrating the portable timing device 100 upon completion of a timing sequence. In addition, portable timer device 100 can be configured to be worn and used by adults suffering from various ailments such as, for example, incontinence or forgetfulness.

What is claimed:

1. A portable potty-training device for small children comprising:
a front portion having a front cover and a front housing, the front housing having an interface surface, a mounting surface and an interior space, the interior space containing a timer and an audio speaker; and
a rear portion having a magnet,
wherein the front portion is positioned with the mounting surface adjacent a first side of clothing and the rear portion is positioned on a second side of clothing such that the magnet magnetically interacts with the mounting surface to maintain the position of a portable potty-training device on the clothing.

2. The portable potty-training device of claim 1, wherein the timer comprises a mechanical timer having an adjustment arm, the adjustment arm projecting through an opening in the interface surface such that a timer duration is settable without accessing the interior space.

3. The portable potty-training device of claim 2, wherein the interface surface comprises a time legend proximate the opening to provide a visual indication as to the time duration.

4. The portable potty-training device of claim 1, wherein the front cover is attached to the front housing with a hinge assembly such that the interface surface is exposed by rotating the front cover away from the front housing.

5. The portable potty-training device of claim 1, wherein the interface surface comprises a plurality of speaker bores into the interior space, the audio speaker mounted proximate the speaker bores for directing an audio signal outside the interior space.

6. The portable potty-training device of claim 1, wherein the front cover comprises a visual element visible when the portable potty-training device is positioned on the clothing, the visual element selected from the group comprising: a cartoon character, a video game character, a movie character, a television character, a literary character, a personal name and a photograph.

7. The portable potty-training device of claim 1, wherein the magnet is encapsulated within the rear portion.

8. The portable potty-training device of claim 1, wherein the front housing comprises a front magnet wherein the front magnet magnetically engages the magnet in the rear portion to maintain the position of the portable potty-training device on the clothing.

9. A method for potty-training small children comprising:
placing a magnetic portion of a wearable device on an interior surface of a piece of clothing worn by a child;
placing a viewable portion of the wearable device on an exterior surface of the piece of clothing such that the magnetic portion interfaces with a rear wall of the viewable portion and the wearable device is positionally maintained on the piece of clothing;
setting a timer contained within the viewable portion to establish a time duration between attempts to use a toilet; and
signaling the child upon expiration of the time duration that the child should attempt use of the toilet.

10. The method of claim 9, further comprising:
providing a book to the child related to potty-training for review by the child during attempted use of the toilet.

11. The method of claim 10, further comprising:
reading the book to the child during attempted use of the toilet.

12. The method of claim 9, further comprising:
attaching a visual feature to a front cover of the viewable portion of the wearable device, the visual feature increasing the child's interest in wearing the wearable device.

13. A system for potty-training small children comprising:
a wearable potty-training device having a front portion and a rear portion, the front portion including an interior space having a timer and an audio speaker and the rear portion having a magnet wherein the front portion is positioned on a first side of clothing and the rear portion is positioned on a second side of clothing such that the magnet magnetically interacts with the front portion to magnetically maintain the position of the wearable potty-training device on the clothing; and
a potty-training book including potty-training material,
wherein the timer is set to a time interval such that upon expiration of the time interval, the timer initiates the audio speaker to provide an audio signal directing a child to attempt use of a toilet, and
wherein the potty-training book reassures the child during attempted use of the toilet.

14. The system of claim 13, wherein the front portion comprises a front cover and a front housing enclosing the interior space, the front cover attached to the front housing with a hinge such that the front cover can be rotated away from an interface surface on the front housing.

15. The system of claim 14, wherein the timer comprises a mechanical timer having an adjustment arm, the adjustment arm projecting through an opening in the interface surface such that the timer duration is settable without accessing the interior space.

16. The system of claim 15, wherein the interface surface comprises a time legend proximate the opening to provide a visual indication as to the time duration.

17. The system of claim 14, wherein the front cover comprises a visual element visible when the portable potty-training device is positioned on the clothing.

18. The system of claim 17, wherein the visual element comprises a fictional character selected from the group comprising: a cartoon character, a video game character, a movie character, a television character and a literary character.

19. The system of claim 18, wherein the potty-training book contains a story based on the fictional character.

20. The system of claim 13, wherein the front portion comprises a front magnet for magnetically engaging the magnet in the rear portion to maintain the position of the wearable potty-training device on the clothing.
